(19) United States
(12) Patent Application Publication
(10) Pub. No.: US 2023/0135839 A1
(43) Pub. Date: May 4, 2023

(54) MASK

(71) Applicant: OMRON CORPORATION, Kyoto-shi (JP)

(72) Inventors: Takahiro ONO, Kyoto-shi (JP); Hiroyuki IBUKI, Kyoto-shi (JP); Yoshihisa ISHIKAWA, Kyoto-shi (JP); Che Cheng NEO, Singapore (SG); Hiroyuki ONITSUKA, Kyoto-shi (JP); Masaaki SUMI, Kyoto-shi (JP); Junya FUJITA, Kyoto-shi (JP); Masanori MORI, Kyoto-shi (JP)

(73) Assignee: OMRON CORPORATION, Kyoto-shi (JP)

(21) Appl. No.: 17/953,384

(22) Filed: Sep. 27, 2022

(30) Foreign Application Priority Data
Oct. 29, 2021 (JP) 2021-177825

(51) Int. Cl. A62B 18/08; A62B 18/02

(52) U.S. Cl. CPC A62B 18/08; A62B 18/02

(57) ABSTRACT

A mask 10 comprises a main body portion 11, a fixing member 12, a display panel 13, an LED 14a, and a display control unit 15. The main body portion 11 is disposed at a shield position that covers the user's mouth and nostrils. The fixing member 12 fixes the main body portion 11 to the face so that the main body portion 11 is held at the shield position. The display panel 13 is provided at a position of the main body portion 11 opposite the front of the user's face, and performs a desired display with light emitted in a specific direction. The LED 14a irradiates the display panel 13 with light in a specific direction. The display control unit 15 controls the LED 14a so as to perform a desired display on the display panel 13.

### CROSS-REFERENCE TO RELATED APPLICATIONS

This application claims priority to Japanese Patent Application No. 2021-177825 filed on Oct. 29, 2021. The entire disclosure of Japanese Patent Application No. 2021-177825 is hereby incorporated herein by reference.

### BACKGROUND

### Technical Field

The present invention relates to a mask worn on the front of a user's face so as to cover at least the nostrils and mouth.

### Description of the Related Art

In recent years, stylish masks have been used that prevent the entry of viruses and pollen, are easy to breathe through, do not become stained with lipstick or the like, do not leave rubber marks on the cheeks, and also serve to retain heat.

For example, Patent Literature 1 discloses a fashionable mask whose front material is made of lace or of colored or patterned fabric.

### CITATION LIST

### Patent Literature

Patent Literature 1: JP-A 2006-167040

### SUMMARY

### Problem to be Solved by the Invention

However, the following problems are encountered with the conventional mask mentioned above.

Although the mask disclosed in the above publication is fashionable because it includes lace or a colored or a patterned fabric, when a mask printed with colors or patterns ends up having just a single design, which is not as much fun.

For example, when players of e-Sports games wear masks to prevent infectiou s diseases, they want a mask that is more fun to wear, as part of how they appear in th e game.

It is an object of the present invention is to provide a mask that is more fun to wear.

### Means for Solving Problem

The mask according to the first invention is a mask that is worn so as to cover at least the mouth and nostrils of the user's face, the mask comprising a main body portion, fixing members, a display panel, a light source, and a display control unit. The main body portion is disposed at a shield position covering the mouth and nostrils of the user. The fixing members fix the main body portion to the face so that the main body portion is held at the shield position. The display panel is provided to the main body portion at a position opposite the front of the user's face and performs a desired display with light emitted in a specific direction. The light source unit irradiates the display panel with light in the specific direction. The display control unit controls the light source unit so as to perform a desired display on the display panel.

Here, a display panel whose display is controlled by the display control unit is attached to the main body portion of the mask, which is worn so as to cover at least the mouth and nostrils of the user's face.

Here, the main body portion is formed of a resin or other such material, for example, and the display panel is attached on the user's face side or on the opposite side.

The fixing members include, for example, stretchable rubber that is provided on both sides of the main body portion and hooked over the user's ears, a string or cloth that is tied at the back of the user's head, a stretchable cylindrical material, or the like.

The display panel includes, for example, a light guide plate or the like that displays a specific pattern or the like with light that is incident from a specific direction.

The light source unit includes, for example, a light emitting diode (LED) that emits light toward the end surface of the display panel.

Consequently, the display panel attached to the main body portion of the mask can display patterns, letters, and the like by lighting them with the light emitted from the light source, and this makes the mask more fun to wear.

Therefore, for example, when a game player plays a game while wearing a mask at a game event venue or the like, the display of the mask can be used as part of the player's costume.

The mask according to the second invention is the mask according to the first invention, wherein the main body portion has a mounting portion to which the display panel is mounted, and the mask further comprises an attachment mechanism for attaching the display panel to the attachment portion in a detachable state.

Consequently, since the display panel is detachably attached to the main body portion, a number of display panels for displaying different patterns can be swapped out, which allows the user to attach the display panel that suits the user's preference to the main body portion.

The mask according to the third invention is the mask according to the second invention, wherein the attachment mechanism includes a magnet that magnetically fixes the display panel to the main body portion.

Consequently, the display panel can be easily attached to and detached from the main body portion by taking advantage of the magnetic force of the magnet.

The mask according to the fourth invention is the mask according to the second or third invention, wherein the attachment mechanism is provided on the surface of the main body portion that is opposite the face, and the display panel is attached to the surface of the main body portion that is opposite the face.

Consequently, the display panel can be attached to the inner surface of the mask (the surface opposite the face), so the display panel can be attached without compromising the aesthetic design of the front of the mask (the surface opposite the face).

The mask according to the fifth invention is the mask according to any of the first to fourth inventions, wherein the display panel has a light guide plate having an incident surface on which light emitted from the light source unit is incident, and an exit surface from which light is emitted toward the main body portion.

Consequently, a light guide plate that displays a specific pattern or the like by emitting light incident from the incident surface toward the exit surface side can be used as the display panel, which allows a desired pattern or the like to be displayed on the display panel with an inexpensive and simple configuration.

The mask according to the sixth invention is the mask according to the fifth invention, wherein the light source unit includes a first light source that is provided to the main body portion at a position opposite the lower end surface of the light guide plate.

Consequently, a specific pattern or the like can be displayed on the light guide plate by causing light to be incident from the first light source disposed opposite the lower end surface of the light guide plate.

The mask according to the seventh invention is the mask according to the fifth invention, wherein the light source unit includes a second light source provided to the main body portion at a position opposite the side end surface of the light guide plate.

Consequently, a specific pattern or the like can be displayed on the light guide plate by causing light to be incident from the second light source disposed opposite at least one of the left and right end surfaces of the light guide plate.

The mask according to the eighth invention is the mask according to the fifth invention, wherein the light source unit includes a first light source that is provided to the main body portion at a position opposite the lower end surface of the light guide plate, and a second light source that is provided to the main body portion at a position opposite the side end surface of the light guide plate.

Consequently, light from either the first light source or the second light source disposed opposite at least one of the lower end surface and the left and right end surfaces of the light guide plate is made to be incident, which allows the specific pattern or the like displayed on the light guide plate to be switched.

The mask according to the ninth invention is the mask according to the fifth invention, wherein the light source unit includes a plurality of first light sources that are provided to the main body portion at positions opposite one end surface of the light guide plate.

Consequently, light can be selectively allowed to be incident at the plurality of first light sources disposed opposite one end surface of the light guide plate, which allows the display of the specific pattern or the like to be switched on the light guide plate.

The mask according to the tenth invention is the mask according to any of the fifth to ninth inventions, wherein the light guide plate further has, on either the upper surface or the lower surface, a plurality of prisms that are arranged to match the desired display and that reflect the light emitted from the light source unit onto the incident surface in a specific direction.

Consequently, the light incident on the incident surface from the light source can be reflected by the prisms inside the light guide plate and emitted from the exit surface, allowing the desired pattern or the like to be displayed on the surface of the main body portion.

The mask according to the eleventh invention is the mask according to any of the fifth to tenth inventions, wherein the light guide plate further has a tapered portion that has a substantially rectangular shape, that is provided at a corner portion of this substantially rectangular shape, and that reflects the light emitted from the light source and incident on the incident surface to change the direction of the light.

Consequently, the light incident from the incident surface can be reflected by the tapered portions provided at the corners of the light guide plate, thereby changing the direction in which the light is traveling. Therefore, for example, in a configuration in which a plurality of light sources are disposed at positions opposite one end surface of the light guide plate, a light source that emits light toward the tapered portions and a light source that does not emit light toward the tapered portions can be switched on and off, which allows the displayed pattern, etc., to be switched.

The mask according to the twelfth invention is the mask according to any of the first to eleventh inventions, wherein the main body portion has a light transmitting portion that transmits light in the portion where the display panel is mounted.

Consequently, providing the light transmitting portion that transmits light in the portion of the main body portion of the mask where the display panel is mounted makes it possible for the display on the display panel to be visible from the outside.

The mask pertaining to the thirteenth invention is the mask pertaining to any of the first to twelfth inventions, wherein the main body portion has a recess on the surface where the display panel is mounted, to expose at least part of the end surface of the display panel.

Consequently, one end surface of the display panel is at least partially exposed on the surface of the main body portion on which the display panel is mounted, which allows the display panel to be removed by placing a finger in the recess.

This recess may be provided at a position corresponding to the nose portion of the user's face. Consequently, the user's nose will not come into contact with the inner surface of the mask, which avoids discomfort during use.

The mask according to the fourteenth invention is the mask according to any of the first to thirteenth inventions, wherein the display control unit controls the light source unit so as to turn the display on and off on the display panel.

Consequently, the light source unit can be switched on and off, allowing the display on the display panel, such as the light guide plate, also to be switched on and off.

The mask according to the fifteenth invention is the mask according to any of the first to fourteenth inventions, wherein the display control unit switches the light source unit that irradiates the display panel with light, so as to switch the display on the display panel.

Consequently, for example, the light source units disposed at positions opposite different end surfaces of the light guide plate or other such display panel can be switched on and off, allowing the pattern, etc., displayed on the display panel to be switched.

The mask according to the sixteenth invention is the mask according to any of the first to fifteenth inventions, further comprising a blower fan that is provided to the main body portion and forms an air flow in a gap between the main body portion and the front of the face.

Consequently, an air flow is formed by the blower fan in the space between the main body portion of the mask and the user's face, which prevents the inside of the mask from fogging up during use. Therefore, this avoids problems such as when the display on the display panel becomes blurry.

The mask according to the seventeenth invention is the mask according to the sixteenth invention, wherein the blower fans are provided on both sides of the display panel.

Consequently, since the blower fans are provided on both sides of the display panel, it is possible to generate an airflow from the left and right sides of the display panel and more effectively prevent the inside of the mask from fogging up.

The mask according to the eighteenth invention is the mask according to the sixteenth or seventeenth invention, wherein the blower fan blows air from the gap between the main body portion and the front of the face to the outside of the main body portion.

Consequently, moist air in the gap between the mask and the user's face can be expelled to the outside, preventing the inside of the mask from fogging up during use and avoiding problems such as when the display on the display panel becomes blurry.

The mask according to the nineteenth invention is the mask according to any of the sixteenth to eighteenth inventions, wherein the main body portion has a plurality of communication holes that communicate the outside air and the gap between the front of the face on the surface on the opposite side from the side opposite the face. The blower fan blows air to the outside of the main body portion through the plurality of communication holes.

Consequently, the outer surface (front) of the mask and the inner surface (back) opposite the user's face can communicate with each other through these communication holes. Therefore, the blower fan can form an air flow from the inside to the outside of the mask through the communication holes, which avoids problems such as when the inside of the mask fogs up.

The mask according to the twentieth invention is the mask according to any of the first to nineteenth inventions, wherein the fixing members are over-the-ear portions that are provided on both the left and right sides of the main body portion and latch to the user's ears in a stretchable state.

Consequently, the over-the-ear portion made of stretchable rubber or the like on both the left and right sides of the main body portion can be hooked on the left and right ears of the user.

The mask according to the twenty-first invention is the mask according to any of the first to twentieth inventions, wherein at least the portion of the main body portion to which the display panel is mounted is molded from a resin that is light-transmissive.

Consequently, since the portion of the main body portion where the display panel is mounted (mounting portion) is molded from a resin that is light-transmissive, the light for displaying a pattern, etc., on the display panel can be seen through the front side of the mask.

### Effects

The present invention provides a mask that is more fun to wear.

### BRIEF DESCRIPTION OF THE DRAWINGS

FIG. 1 is an overall oblique view of the configuration of the mask according to an embodiment of the present invention;

FIG. 2A is a top view of the mask in FIG. 1, and FIG. 2B is a front view of FIG. 1;

FIG. 3A is a side view of the mask in FIG. 1, and FIG. 3B is a rear view of the configuration of the back side in FIG. 3A;

FIG. 4 is an oblique view of a display panel that can be attached to and detached from the main body portion of the mask in FIG. 1;

FIG. 5 is a cross-sectional view along the A-A line in FIG. 2B;

FIG. 6 is a control block diagram of the mask in FIG. 1;

FIG. 7 is a cross-sectional view along the C-C line in FIG. 2B;

FIG. 8 is an oblique view of the configuration of the display panel in FIG. 4;

FIG. 9 is a front view of the display panel in FIG. 8;

FIG. 10A is a cross-sectional view along the B-B line in FIG. 9, and FIG. 10B is a cross-sectional view of the incident surface and the exit surface of the display panel, and internal prisms;

FIG. 11A is a plan view of the positional relation between the display panel and the light source unit according to another embodiment of the present invention, and FIG. 11B is a side view of FIG. 11A;

FIG. 12A is a plan view of the positional relation between the display panel and the light source unit according to yet another embodiment of the present invention, and FIG. 12B is a side view of FIG. 12A;

FIG. 13A is a plan view of the positional relation between the display panel and the light source unit according to yet another embodiment of the present invention, and FIG. 13B is a plan view showing the layout of prisms disposed in the pattern of FIG. 13A; and

FIG. 14A is a plan view of the positional relation between the display panel and the light source unit according to yet another embodiment of the present invention, and FIG. 14B is a plan view showing the layout of prisms disposed in the pattern of FIG. 14A.

### DETAILED DESCRIPTION OF THE EMBODIMENTS

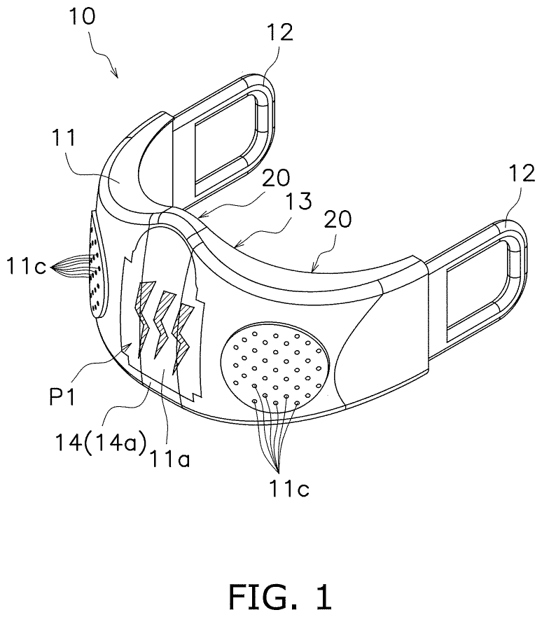

The mask 10 according to an embodiment of the present invention will now be described with reference to FIGS. 1 to 10B.

In this embodiment, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### (1) Configuration of Mask 10

The mask 10 according to this embodiment is, for example, a mask worn by a game player of an e-Sports or the like while playing a game. On the surface of the main body portion 11 of the mask 10, the display of a desired pattern P1 is switched on and off.

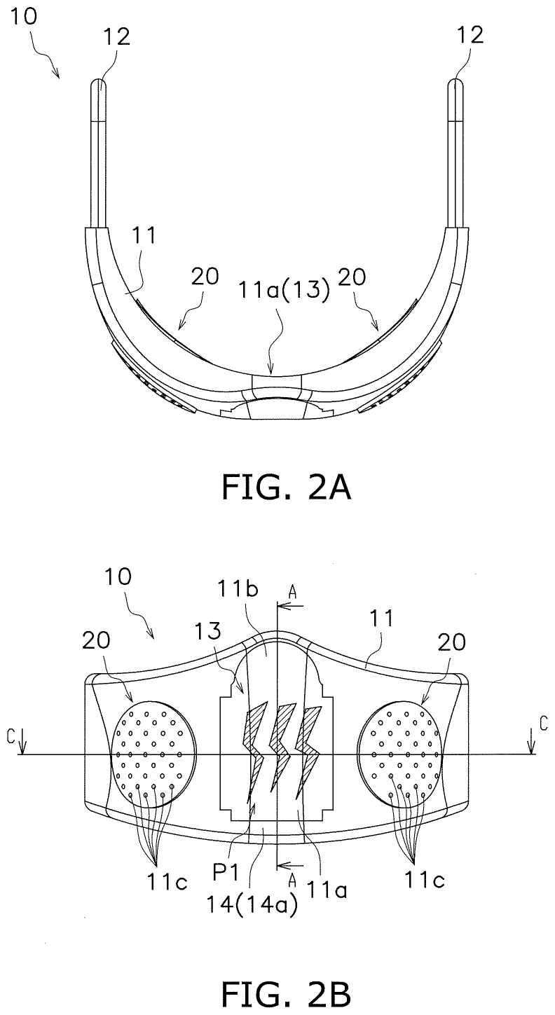

Here, the desired pattern P1 is displayed on the display panel 13 (discussed below). For example, as shown in FIGS. 1 and 2B, this can be a design such as lightning bolts, or can be text, graphics, symbols, or any of various other patterns.

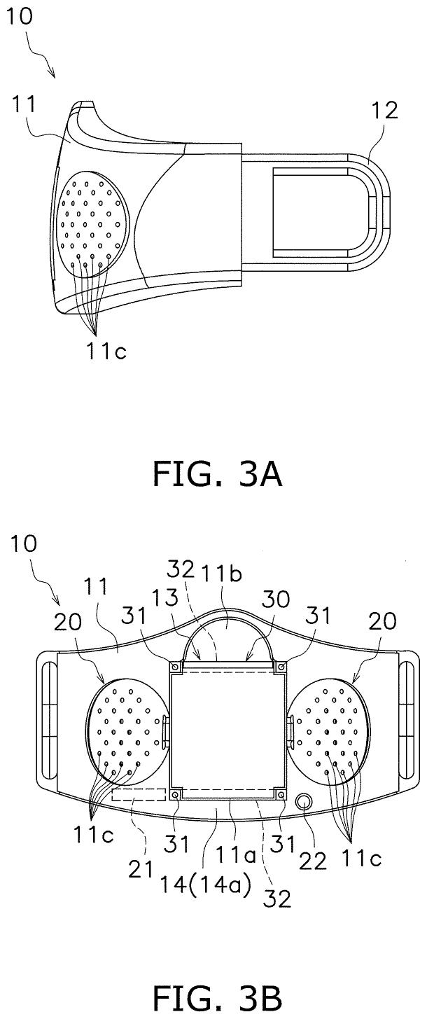

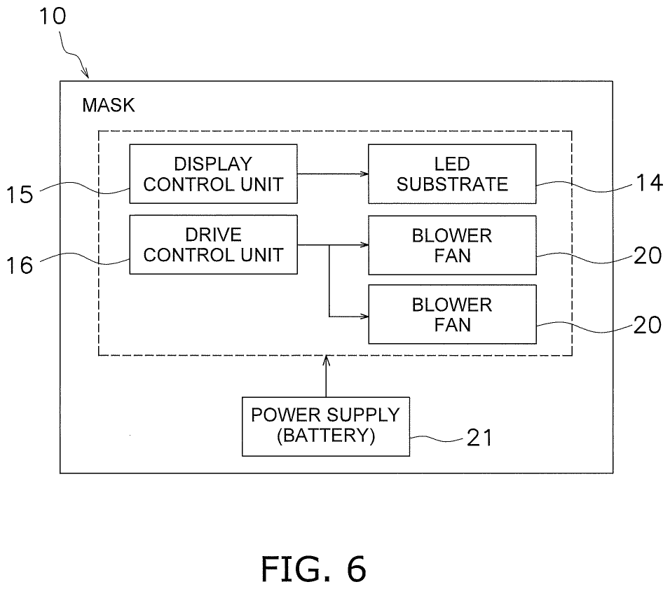

As shown in FIG. 1, the mask 10 comprises the main body portion 11, fixing members (over-the-ear portions) 12, a display panel 13, an LED substrate 14, a display control unit 15, a drive control unit 16 (see FIG. 6), blower fans 20, and a power supply unit 21, and a switch button 22 (see FIG. 3B).

The main body portion 11 is made of a colored polycarbonate (PC) or other such resin, for example, and as shown in FIGS. 1 and 2A, has a curved shape that matches the shape of the front of the user's face. The main body portion 11 has a mounting portion (light transmitting portion) 11a to which the display panel 13 is detachably mounted, a recess 11b, and communication holes 11c.

As shown in FIGS. 2A and 3B, the mounting portion 11a is a substantially rectangular recessed portion that is provided on the inner surface of the main body portion 11 of the mask 10 (the surface opposite the front of the user's face), and the display panel 13 is attached in a detachable state. Also, the mounting portion 11a is molded from a resin (PC or the like) that transmits light.

Consequently, the pattern P1 displayed on the display panel 13 attached inside the mask 10 is visible from the front side of the mask 10. Furthermore, metal plates 32 that constitute an attachment mechanism 30 (discussed below) are embedded in at least the four corners of the approximately rectangular mounting portion 11a.

As shown in FIGS. 2B and 3B, the recess 11b is formed as a substantially semicircular recessed portion provided to the upper part of the recessed portion of the substantially rectangular mounting portion 11a, at a position that is opposite the user's nose on the inner surface of the main body portion 11. When the display panel 13 is mounted to the mounting portion 11a, the recess 11b forms a state in which the upper end surface of the display panel 13 is exposed. Consequently, when the display panel 13 is to be replaced, etc., the user can remove the display panel 13 from the mounting portion 11a by inserting a finger into the recess 11b, grasping the upper end surface of the display panel 13, and pulling this out.

As shown in FIG. 2B, the communication holes 11c are provided on the left and right sides of the mounting portion 11a of the main body portion 11, and allow the inner surface and the outer surface of the mask 10 to communicate. Also, the communication holes 11c allow the air flow formed by the blower fans 20 provided on the left and right sides of the mounting portion 11a in the main body portion 11 to pass through.

The fixing members (over-the-ear portions) 12 are formed, for example, from an elastic elastomer-based resin or rubber-based material, and are attached by being hooked over the user's ears. Also, as shown in FIGS. 2A and 3A, the fixing members 12 are connected to the left and right ends of the main body portion 11, which has a curved shape, and are formed so as to extend rearward from the back side of the main body portion 11 (the user's face side). This allows the main body portion 11 of the mask 10 to be fixed at a shield position that covers the mouth and nostrils of the user's face.

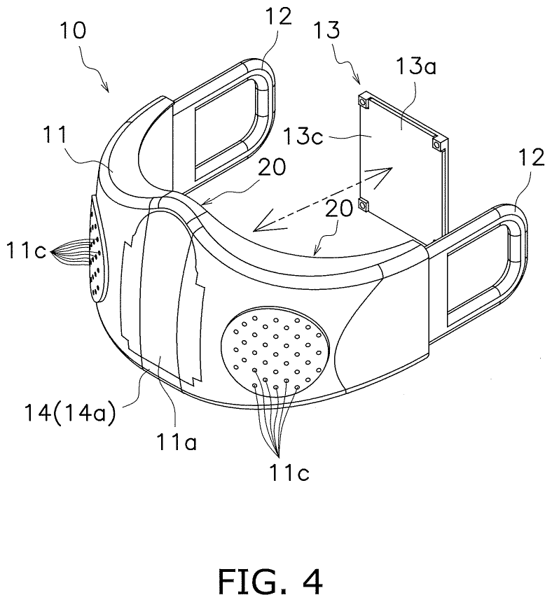

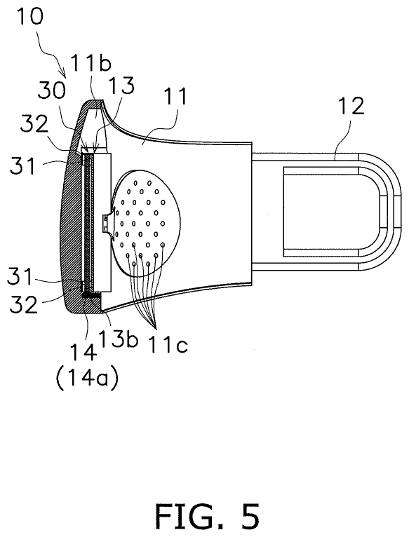

The display panel 13 is constituted by, for example, a substantially rectangular light guide plate made of resin such as acrylic or PC (polycarbonate), and displays the desired pattern P1 as shown in FIG. 2B, etc. As shown in FIG. 3B, the display panel 13 is mounted so as to be fitted into the recess of the mounting portion 11a of the main body portion 11. Also, as shown in FIG. 4, the display panel 13 is attached to the mounting portion 11a, which is formed on the inner surface of the mask 10, in a detachable state via an attachment mechanism 30 (discussed below) (see FIG. 5, etc.). The display panel 13 is configured to internally reflect incident light emitted from LEDs 14a (discussed below), and to emit the light from the front surface of the mask 10 (exit surface 13c). Consequently, the display panel 13 can display the desired pattern P1 when viewed from the front side of the mask 10.

The detailed configuration of the display panel 13 will be described below.

The LED substrate 14 has a plurality of LEDs (light source units) 14a disposed on the substrate. As shown in FIG. 5, the LED substrate 14 is disposed on the lower part of the mounting portion 11a on which is mounted the display panel 13 of the main body portion 11.

As shown in FIG. 5, the LEDs 14a emit light from the lower part of the mounting portion 11a of the main body portion 11 to which the display panel 13 is mounted, toward the lower end surface 13b of the display panel 13.

As shown in FIG. 6, the display control unit 15 is electrically connected to the LED substrate 14, and controls the on and off switching of the LEDs 14a disposed on the LED substrate 14.

This allows the display of the desired pattern P1 to be switched on and off in a front view of the mask 10.

As shown in FIG. 6, the drive control unit 16 is electrically connected to the two blower fans 20, and performs control so that the rotation shafts of the blower fans 20 are rotated by electric power supplied from the power supply unit 21 to generate an air flow.

The drive control unit 16 may perform control such that the rotation shafts of the two blower fans 20 rotate at a constant rotation speed, or such that the rotation speed varies according to the setting.

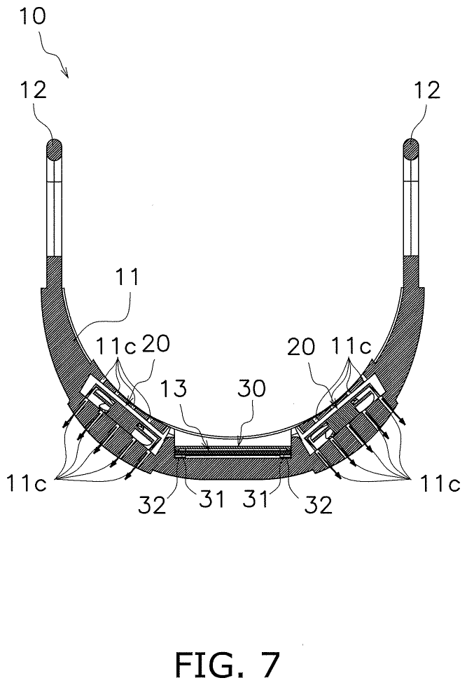

As shown in FIGS. 2B, 3B, etc., the blower fans 20 are provided on the left and right sides of the mounting portion 11a on which the display panel 13 is mounted, in the main body portion 11 of the mask 10. As shown in FIG. 7, the blower fans 20 blow air from the inside to the outside of the mask 10 through the communication holes 11c formed on the front and back sides of the main body portion 11 (see the arrows in FIG. 7).

Consequently, the air inside the mask 10 is continuously expelled to the outside, so fogging inside the mask 10 can be effectively suppressed. This suppresses the surface of the display panel 13 attached to the inside of the mask 10 from fogging up.

The power supply unit 21 is a rechargeable secondary battery, for example, and as shown in FIG. 3B, is built into the lower part of one of the blower fans 20 in the main body portion 11. The power supply unit 21 supplies electric power to the LEDs 14a, the blower fans 20, and so forth.

The switch button 22 is operated when the desired pattern P1 is to be displayed on the display panel 13, and as shown in FIG. 3B, is provided on the inner surface of the main body portion 11 of the mask 10 at a position on the opposite side (left and right) from the power supply unit 21.

The switch button 22 not only switches the display of the display panel 13 on and off (whether or not the LEDs 14a are lit), but may also be used as an on/off switch for the blower fans 20, such as by rotating the blower fans 20 when pressed twice.

The attachment mechanism 30 is provided in order to attach the display panel 13 to the mounting portion 11a of the main body portion 11 in a detachable state. The attachment mechanism 30 has a plurality of magnets 31 provided on the display panel 13 side, and metal plates 32 provided on the mounting portion 11a side.

The magnets 31 are provided at the four corners of the surface of the substantially rectangular display panel 13 that is opposite the mounting portion 11a.

The metal plates 32 are provided at positions corresponding to the four corners of the display panel 13 on the mounting portion 11a of the main body portion 11, and are attracted by the magnetic force of the magnets 31.

Consequently, when the display panel 13 is mounted to the mounting portion 11a of the main body portion 11, the display panel 13 is held by the magnetic force of the magnets 31 at the positions of the plates 32.

The metal plates 32 may be magnets that attract the magnet 31. Also, the number of magnets 31 may be more than four or three or less, so long as the magnets are strong enough to hold the display panel 13 detachably.

### (2) Configuration of Display Panel 13

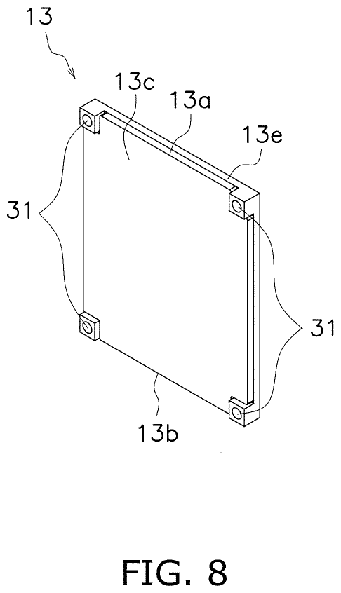

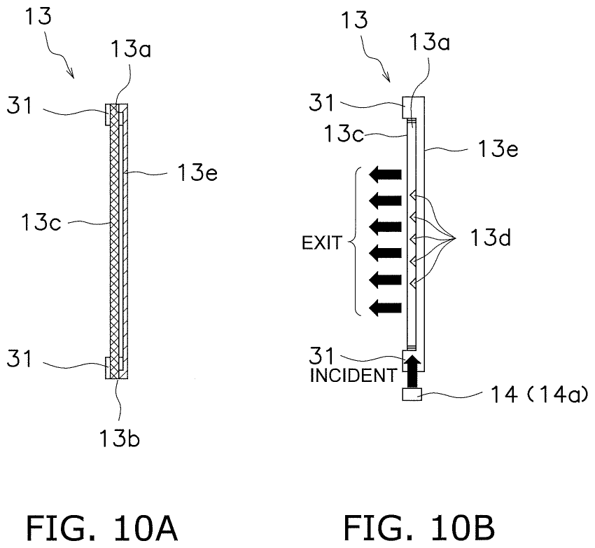

In the mask 10 of this embodiment, as shown in FIG. 8, the display panel 13 for displaying the desired pattern P1 has a main body portion 13a, lower end surface (incident surface) 13b, an exit surface 13c, prisms 13d (see FIG. 10B), and a protective panel 13e.

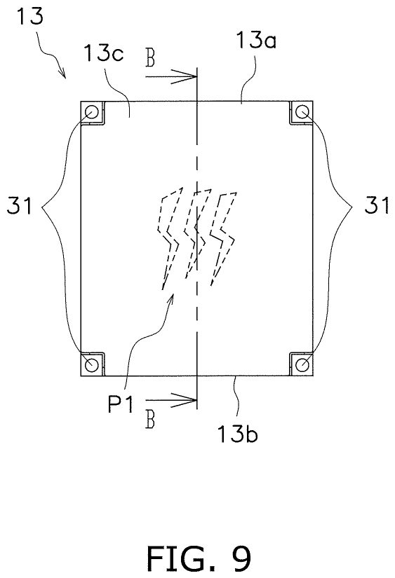

The main body portion 13a is a substantially rectangular plate-shaped member, and is formed from a transparent resin such as an acrylic resin, as discussed above. As shown in FIGS. 8 and 9, the magnets 31 constituting the attachment mechanism 30 are provided at the four corners of the surface of the substantially rectangular main body portion 13a on the side to be mounted to the mounting portion 11a. The prisms 13d (see FIG. 10B), which are disposed to match the shape of the desired pattern P1, are provided inside the main body portion 13a.

The lower end surface (incident surface) 13b is disposed at a position opposite the LED substrate 14 when the display panel 13 is mounted to the mounting portion 11a of the main body portion 11. Consequently, the lower end surface 13b becomes an incident surface on which the light emitted from the LEDs 14a is incident.

As shown in FIGS. 8 and 10A, the exit surface 13c is the surface located on the mounting portion 11a side when the display panel 13 is mounted to the mounting portion 11a of the main body portion 11. As shown in FIG. 10B, the light incident from the lower end surface 13b is reflected by the prisms 13d and emitted from the exit surface 13c. Consequently, as shown in FIG. 9, the desired pattern P1 can be displayed according to the layout of the prisms 13d.

As shown in FIG. 10B, the prisms 13d are microfabricated on the inside of the main body portion 13a (light guide plate), on the opposite side from the mounting side, and as shown in FIG. 10A and FIG. 10B, these prisms reflect the light incident from the lower end surface 13b in a specific direction. Also, the prisms 13d are disposed so as to cover the range of the pattern P1 displayed when the LEDs 14a are lit.

As shown in FIGS. 10A and 10B, the protective panel 13e is attached so as to cover the surface of the main body portion 13a on the opposite side from the mounting portion 11a when the display panel 13 is mounted to the mounting portion 11a of the main body portion 11. Consequently, the main body portion 13a is protected in a state in which the surface on the opposite side from the exit surface 13c is covered.

### Main Features

As shown in FIG. 4, etc., the mask 10 of this embodiment comprises the main body portion 11, the fixing members 12, the display panel 13, the LEDs 14a, and the display control unit 15. The main body portion 11 is disposed at a shield position that covers the user's nostrils and mouth. The fixing members 12 fix the main body portion 11 to the face so that the main body portion 11 is held at the shield position. The display panel 13 is provided at a position of the main body portion 11 opposite the front of the user's face, and performs the desired display with light emitted in a specific direction. The LEDs 14a irradiate the display panel 13 with light from a specific direction. The display control unit 15 controls the LEDs 14a so as to perform the desired display on the display panel 13.

Consequently, in the display panel 13 attached to the main body portion 11 of the mask 10, the pattern P1, etc., can be displayed by lighting with the light emitted from the LEDs 14a, which means that the mask 10 will be much more fun to wear.

Therefore, when a game player plays a game wearing the mask 10 at a game event site, etc., for example, the display on the mask 10 can be used as a part of the player's costume.

### Other Embodiments

An embodiment of the present invention was described above, but the present invention is not limited to or by the above embodiment, and various modifications are possible without departing from the gist of the invention.

(A)

In the above embodiment, an example was given in which the desired pattern P1 was displayed on the exit surface 13c with light emitted from the LEDs (light source) 14a disposed at positions opposite the lower end surface 13b of the display panel 13, toward the lower end surface 13b. However, the present invention is not limited to this.

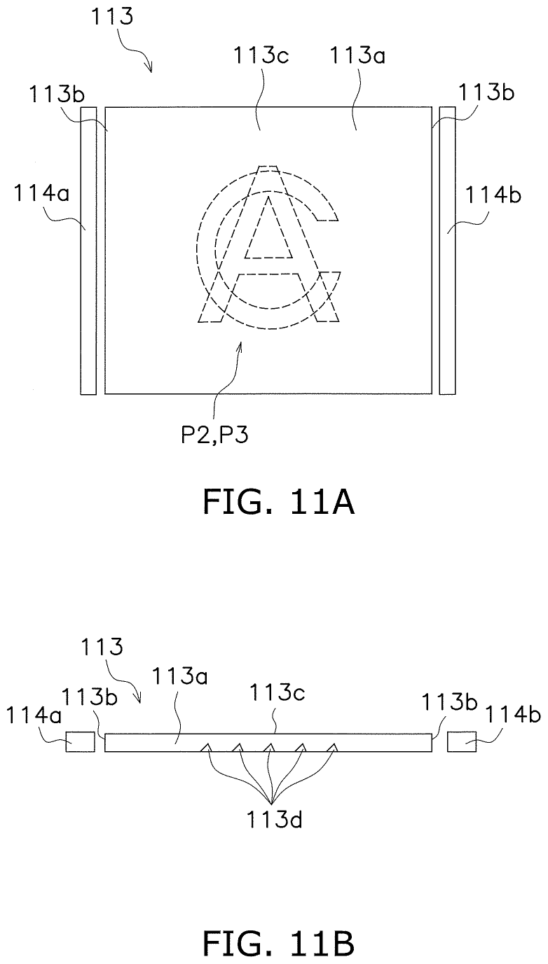

For example, as shown in FIGS. 11A and 11B, desired patterns P2a (A) and P3 (C) are displayed on an exit surface 113c with light emitted from LEDs (second light source) 114a and LEDs (second light source) 114b disposed at positions that are opposite side end surfaces 113b on the left and right sides of a main body portion 113a of a display panel 113, toward the side end surfaces 113b.

In this case, for example, the display control unit 15 performs control so that light is emitted from either the LEDs (first light source unit) 114a or the LEDs (second light source unit) 114b, thereby changing the prisms 113d that reflect the light and allowing switching between the pattern P2 (A) or the pattern P3 (C) displayed on the exit surface 113c.

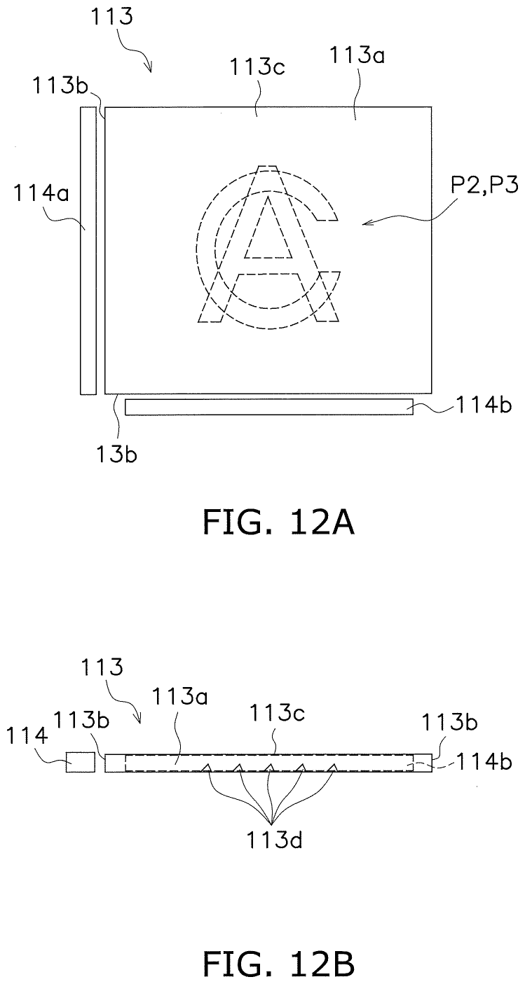

For example, as shown in FIGS. 12A and 12B, desired patterns P2 (A) and P3 (C) are displayed on the exit surface 113c with the light emitted from the LEDs (second light source) 114a and LEDs (first light source) 114b disposed at positions that are opposite the side end surface 113b and the lower end surface 13b of the main body portion 113a of the display panel 113, toward the side end surface 113b and the side end surface 113b.

In this case, for example, the display control unit 15 performs control so that light is emitted from either the LEDs (second light source) 114a or the LEDs (first light source) 114b, thereby changing the prisms 113d that reflect the light, which allows switching between the pattern P2 (A) or the pattern P3 (C) displayed on the exit surface 113c.

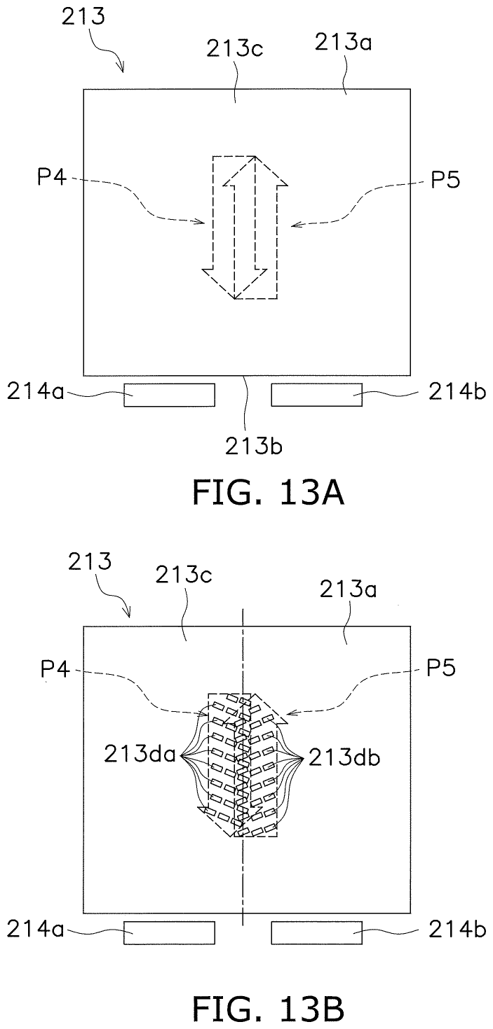

For example, as shown in FIGS. 13A and 13B, desired patterns P4 (downward arrow) and P5 (upward arrow) are displayed on an exit surface 213c with the light emitted from a plurality of LEDs (first light source) 214a and LEDs (second light source) 214b disposed at positions that are opposite one end surface 213b of a main body portion 213a of a display panel 213, toward the one end surface 213b.

In this case, for example, the display control unit 15 performs control so that light is emitted from either the LEDs (first light source) 214a or the LED (second light source) 214b, thereby changing prisms 213da and 213db that reflect the light, allowing switching between the patterns P4 (downward arrow) and pattern P5 (upward arrow) displayed on the exit surface 213c.

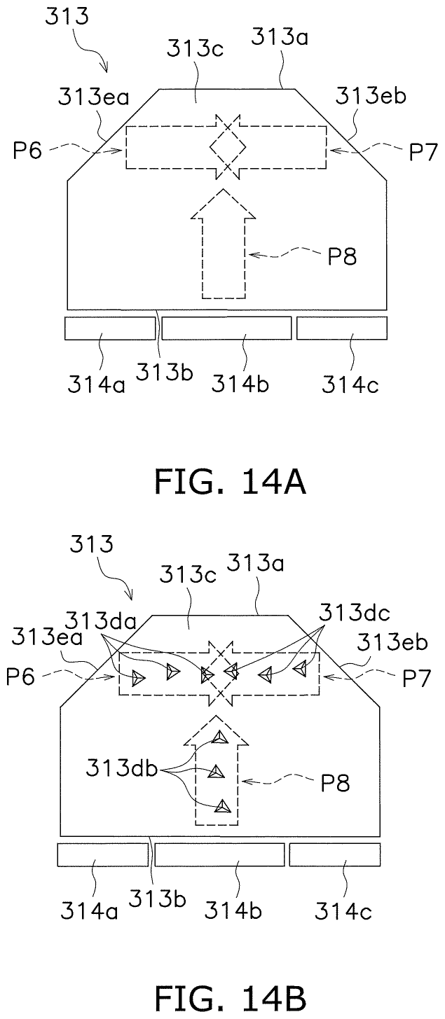

For example, as shown in FIGS. 14A and 14B, desired patterns P6 (rightward arrow), P7 (leftward arrow), and P8 (upward arrow) are displayed on an exit surface 313c with the light emitted from a plurality of LEDs (first light source) 314a, LEDs (second light source) 314b, and LEDs (third light source) 314c disposed at positions that are opposite one end surface 313b of a main body portion 313a of a display panel 313, toward the one end surface 313b.

In this case, for example, the display control unit 15 performs control so that light is emitted from either the LEDs 314a, 314b, or 314c, thereby changing the prisms 313da, 313db, and 313dc that reflect the light, allowing switching of the patterns P6 (rightward arrow), P7 (leftward arrow), and P8 (upward arrow) displayed on the exit surface 313c.

More precisely, the display control unit 15 performs control so that the light from the LEDs 314a irradiates the one end surface 313b, the result being that the light reflected at tapered portions 313ea formed at the upper two corners of the main body portion 313a irradiates the prisms 313da, and a pattern P6 (rightward arrow) is displayed.

Also, the display control unit 15 performs control so that light from the LEDs 314b irradiates the one end surface 313b, the emitted light directly irradiates the prisms 313db, and the pattern P8 (rightward arrow) is displayed.

Furthermore, the display control unit 15 performs control so that light from the LEDs 314c irradiates the one end surface 313b, the light reflected at the tapered portions 313eb formed at the upper two corners of the main body portion 313a irradiates the prisms 313dc, and the pattern P7 (rightward arrow) is displayed.

(B)

In the above embodiment, an example was given in which light was emitted from the LEDs 14a disposed opposite the lower end surface 13b of the display panel 13 to display a desired pattern P1 on the mask surface. However, the present invention is not limited to this.

For example, the position where the light source is disposed may be a position opposite the other end surface as described in (A) above, or may be the rear side, on the opposite side from the exit surface 13c.

(C)

In the above embodiment, an example was given in which the display panel 13 was mounted to the main body portion 11 in a detachable state in order to change the type of pattern displayed on the surface of the mask 10. However, the present invention is not limited to this.

For example, the mask may have the display panel fixed to the mask main body in a non-detachable state, with an adhesive, screws, or the like.

(D)

In the above embodiment, an example was given in which a plurality of magnets were used as the attachment mechanism 30, which is mounted to the main body portion 11 of the mask 10 in a detachable state. However, the present invention is not limited to this.

For example, instead of a plurality of magnets, a mechanism may be employed in which latching portions and latched portions are put together detachably.

(E)

In the above embodiment, an example was given in which a light guide plate was used as the display panel 13. However, the present invention is not limited to this.

For example, some other display panel, such as a liquid crystal display panel or an organic EL (electroluminescence) panel, may be used as the display panel for displaying the desired pattern on the mask surface.

(F)

In the above embodiment, an example was given in which the portion (mounting portion 11a) of the main body portion 11 to which the display panel 13 was mounted was molded from a resin material that transmits light. However, the present invention is not limited to this.

For example, the entire main body portion may be molded from a resin that transmits light.

(G)

In the above embodiment, an example was given in which the blower fans 20 were provided on the left and right sides of the display panel 13 in the main body portion 11 of the mask 10. However, the present invention is not limited to this.

For example, the mask need not have any blower fans.

Alternatively, a blower fan may be located at just one place on the lower side of the display panel, instead of on the left and right sides of the display panel.

(H)

In the above embodiment, an example was given in which the surface of the display panel 13 was prevented from fogging up by sending the air inside the mask 10 to the outside with the blower fans 20. However, the present invention is not limited to this.

For example, the direction of the air blown by the blower fans is not limited to being from the inside to the outside of the mask, and the configuration may be such that the air is blown from the outside to the inside.

Also, the configuration may be such that one of the two blower fans provided on the left and right sides of the display panel in the main body portion of the mask blows air from the inside to the outside of the mask, and the other blows air from the outside to the inside of the mask.

Consequently, the air inside the mask can be efficiently circulated, so fogging of the display panel disposed inside the mask can be effectively suppressed.

(I)

In the above embodiment, an example was given in which the mask 10 was fixed to the user's face with the fixing members (over-the-ear portions) 12 made of an elastic material. However, the present invention is not limited to this.

For example, instead of over-the-ear portions molded from an elastic material, a configuration in which the mask is fixed by tying at the back of the user's head, a configuration in which the mask is fixed with a cylindrical, stretchable material like a neck warmer, or some other such fixing member may be used.

(J)

In the above embodiment, an example was given in which the main body portion 11 and the fixing members 12 were formed from different materials. However, the present invention is not limited to this.

For example, the main body portion and the fixing members may be formed from the same material.

(K)

In the above embodiment, an example was given in which the user of the mask 10 of the present invention was a game player of an e-Sports player or the like. However, the present invention is not limited to this.

People who wear a mask that can display a desired pattern at a desired position at a desired timing when viewed from the front are not limited to game players, and also include users who wear masks in a wider range of fields.

### INDUSTRIAL APPLICABILITY

The mask of the present invention has the effect of providing a mask that is much more fun to wear, and as such can be widely applied to masks used in various situations.

### REFERENCE SIGNS LIST

10 mask
11 main body portion
11a mounting portion (light transmitting portion)
11b recess
11c communication hole
12 fixing member (over-the-ear portion)
13 display panel (light guide plate)
13a main body portion
13b lower end surface (incident surface)
13c exit surface
13d prism
13e protective panel
14 LED substrate
14a LED (light source)
15 display control unit
16 drive control unit
20 blower fan
21 power supply unit (battery)
22 switch button
30 attachment mechanism
31 magnet
32 plate
113 display panel (light guide plate)
113a main body portion
113b side end surface (incident surface)
113c exit surface
113d prism
114a LED (second light source)
114b LED (second light source, first light source)
213 display panel (light guide plate)
213a main body portion
213b one end surface (incident surface)
213c exit surface
213da, 213db prism
214a LED (first light source)
214b LED (first light source)
313 display panel (light guide plate)
313a main body portion
313b one end surface (incident surface)
313c exit surface
313da, 313db, 313dc prism
313ea, 313eb tapered portion
314a LED (first light source)
314b LED (first light source)
314c LED (first light source)
P1 to P8 pattern

1. A mask that is worn so as to cover at least a mouth and nostrils of a user's face, the mask comprising:
a main body portion that is disposed at a shield position covering the mouth and nostrils of the user;
a fixing member configured to fix the main body portion to the face so that the main body portion is held at the shield position;
a display panel that is provided to the main body portion at a position opposite a front of the user's face and configured to perform a desired display with light emitted in a specific direction;
a light source unit configured to irradiate the display panel with light in the specific direction; and
a display control unit configured to control the light source unit so as to perform a desired display on the display panel.

2. The mask according to claim 1,
wherein the main body portion has a mounting portion to which the display panel is mounted, and
the mask further comprises an attachment mechanism configured to attach the display panel to an attachment portion in a detachable state.

3. The mask according to claim 2,
wherein the attachment mechanism includes a magnet configured to magnetically fix the display panel to the main body portion.

4. The mask according to claim 2,
wherein the attachment mechanism is provided on a surface of the main body portion that is opposite the face, and
the display panel is attached to the surface of the main body portion that is opposite the face.

5. The mask according to claim 1,
wherein the display panel has a light guide plate having an incident surface on which light emitted from the light source unit is incident, and an exit surface from which light is emitted toward the main body portion.

6. The mask according to claim 5,
wherein the light source unit includes a first light source that is provided to the main body portion at a position opposite a lower end surface of the light guide plate.

7. The mask according to claim 5,
wherein the light source unit includes a second light source that is provided to the main body portion at a position opposite a side end surface of the light guide plate.

8. The mask according to claim 5,
wherein the light source unit includes a first light source that is provided to the main body portion at a position opposite a lower end surface of the light guide plate, and a second light source that is provided to the main body portion at a position opposite a side end surface of the light guide plate.

9. The mask according to claim 5,
wherein the light source unit includes a plurality of first light sources that are provided to the main body portion at positions opposite one end surface of the light guide plate.

10. The mask according to claim 5,
wherein the light guide plate further has, on either an upper surface or a lower surface, a plurality of prisms that are arranged to match the desired display and configured to reflect the light emitted from the light source unit onto the incident surface in a specific direction.

11. The mask according to claim 5,
wherein the light guide plate further has a tapered portion that has a substantially rectangular shape, that is provided at a corner portion of this substantially rectangular shape, and that reflects the light emitted from the light source unit and incident on the incident surface to change a direction of the light.

12. The mask according to claim 1,
wherein the main body portion has a light transmitting portion configured to transmit light in a portion where the display panel is mounted.

13. The mask according to claim 1,
wherein the main body portion has a recess on a surface where the display panel is mounted, to expose at least part of an end surface of the display panel.

14. The mask according to claim 1,
wherein the display control unit controls the light source unit so as to turn a display on and off on the display panel.

15. The mask according to claim 1,
wherein the display control unit switches the light source unit that irradiates the display panel with light, so as to switch a display on the display panel.

16. The mask according to claim 1,
further comprising a blower fan that is provided to the main body portion and configured to form an air flow in a gap between the main body portion and the front of the face.

17. The mask according to claim 16,
wherein the blower fans are provided on both sides of the display panel.

18. The mask according to claim 16,
wherein the blower fans blow air from the gap between the main body portion and the front of the face to an outside of the main body portion.

19. The mask according to claim 16,
wherein the main body portion has a plurality of communication holes that communicate an outside air and the gap between the front of the face, on a surface on an opposite side from a side opposite the face, and
the blower fans blow air to an outside of the main body portion through the plurality of communication holes.

20. The mask according to claim 1,
wherein the fixing member is an over-the-ear portion that is provided on both left and right sides of the main body portion and latches to user's ears in an extendable state.

21. The mask according to claim 1,
wherein at least a portion of the main body portion to which the display panel is mounted is molded from a resin that is light-transmissive.
